(19) United States
(12) Patent Application Publication
(10) Pub. No.: US 2025/0282107 A1
(43) Pub. Date: Sep. 11, 2025

(54) FIBER APPLICATION MACHINE WITH APPLICATION HEAD PROVIDED WITH A TENSION LIMITING SYSTEM

(71) Applicant: CORIOLIS GROUP, Queven (FR)

(72) Inventors: Loïc GAILLARD, Lanester (FR); Julien COUDURIER, Lorient (FR)

(21) Appl. No.: 18/862,508

(22) PCT Filed: Apr. 25, 2023
(86) PCT No.: PCT/FR2023/000051

§ 371 Date: Nov. 1, 2024

(30) Foreign Application Priority Data
May 2, 2022 (FR) FR2204153

(51) Int. Cl. B29C 70/38; B29C 70/16

(52) U.S. Cl. CPC B29C 70/384; B29C 70/16

(57) ABSTRACT

A fiber application machine comprising a fiber application head comprising a fixed portion and a movable portion slidably mounted on the fixed portion and biased by at least one compacting cylinder. The movable portion comprises an application roller, and a guide system for guiding at least one fiber (F1, F2) to the application roller in a guide plane (P1, P2). The machine further comprises a tension-limiting system comprising at least one cylinder on which each fiber is able to be at least partially wound, and drive means capable of rotating the cylinder. The tension-limiting system is mounted on the movable portion of the head, upstream of the guide system.

### CROSS-REFERENCE TO RELATED APPLICATIONS

The present application is a U.S. National Phase of PCT/FR/000051, filed Apr. 25, 2023, which claims priority to French Application No. FR2204153, filed May 2, 2022, the complete disclosures of which are hereby incorporated by reference in their entirety.

### TECHNICAL FIELD

The present invention relates to a fiber application machine equipped with a particular tension limiting system, as well as a method for manufacturing a composite material part by means of such a machine.

### BACKGROUND

It is known, in particular in patent document WO2006/092514, fiber application machines for the automatic lay-up on a lay-up surface, such as the surface of a male or female mold, of a wide band formed of one or more fibers, in particular flat continuous fibers of the ribbon type, commonly called tows, in particular carbon fibers consisting of a multitude of carbon threads or filaments.

These machines, conventionally called fiber placement machines, conventionally comprise a fiber application head comprising a fixed portion and a movable portion, the movable portion comprising an application roller for the application of at least one fiber, in particular a band formed of one or more fibers, onto an application surface, and a guide system for guiding at least one fiber towards application roller along a guide plane, and for each fiber, a fiber cutting system, a fiber rerouting system, and a fiber clamping system. The moving portion is slidably mounted on the fixed portion, and is biased by at least one compaction jack. These machines also include fiber storage means, 30 such as a remote spool creel, conveying means for conveying fibers from to storage means to the head, and a displacement system able, for example, to displace the head relative to the lay-up surface.

The conveying means can comprise flexible tubes, each flexible tube being able to receive a fiber in its internal passage and preferably being provided with at least one longitudinal flexible blade arranged substantially parallel to the plane of transport of the fiber received in the internal passage of the flexible tube. Such flexible tubes constitute conveying means that are simple in design, compact in size and low in cost, making it possible to achieve high moving speeds, to offset the storage means from the displacement system, to isolate the fibers from the outside, and to simplify the displacement system of the application head, in particular to use a displacement system such as a poly-articulated arm of the standard six-axis robot type.

In order to limit the tension in the fiber, it was proposed in the above-mentioned patent document to provide at least one tension limiting system, arranged between the fiber storage means and the application head, the tension limiting system comprising at least two cylinders parallel to each other, on which a plurality of fibers are able to be partially wound, and drive means for driving the cylinders in rotation at substantially the same speed. The drive means are controlled by a machine control unit, so that the peripheral speeds of the cylinders are greater than the fiber moving speeds, at the application roller, to exert a tensile force on the fibers coming from the storage means, in order to limit the fiber take-up tension at the application roller, whatever the fiber moving speed. The tension limiting system is typically placed in the creel or at the creel exit, or along the fiber path defined by the conveying means, between the storage means and the head. Such a tension limiting system makes it possible to unwind several spools or several balls of fiber with a single control system, for fibers travelling at different speeds at the application head. The tension limiting system reduces the tension of the fibers at the application roller, regardless of their speed.

The machines available today with this kind of tension limiting system enable one or more fibers to be applied with a low tension. However, this low residual tension can adversely affect lay-up quality, especially when lay-up is carried out at high speeds, and more particularly when fibers are cut and rerouted on the fly at high speeds.

### SUMMARY

The aim of the present invention is to propose a solution to overcome the aforementioned drawbacks.

To this end, embodiments of the present invention proposes a fiber application machine for the production of composite material parts, comprising
a fiber application head comprising a support structure or fixed portion and a movable portion, the movable portion comprising
a compacting system comprising at least one application roller for the application of at least one fiber, in particular a band formed from one or more fibers, onto an application surface,
a guide system for guiding at least one fiber towards the application roller along a guide plane, and
a fiber cutting system and a fiber rerouting system, and preferably a fiber clamping system,
the mobile portion being slidably mounted on the fixed portion along a sliding plane, and being biased by at least one compaction jack mounted between the fixed portion and the mobile portion,
the machine further comprising a tension limiting system comprising at least one cylinder on which each fiber is able to be partially wound, and drive means able to drive the cylinder in rotation, so that the peripheral speed of the cylinder is greater than the moving speed of the fiber in the head,
characterized in that the tension limiting system is mounted on the movable portion of the application head, upstream of the guide system with respect to the direction of advancement of the fiber in the head.

According to an embodiment of the invention, a tension limiting system is mounted on the moving portion of the head, as close as possible to the rerouting system, the cutting system and the compaction system, preferably without an intermediate return system interposed between the tension limiting system and the compaction system, so that the fiber tension during lay-up is as low as possible. This very low fiber tension in the head enables precise positioning of the fiber ends at high lay-up speeds, e.g. more than 1 m/s, particularly during on-the-fly fiber cutting and/or fiber rerouting. The low fiber tension avoids problems, such as slippage, during rerouting of the fiber and thus enables precise positioning of the fiber ends. This low fiber tension also makes it possible to increase the fiber lay-up capacity with a high degree of curvature in the plane of the fiber, conventionally referred to as “steering”. In the case of a head able to apply a band of fibers, a tension limiting system thus positioned on the moving portion makes it possible to have a fiber tension at the application roller which is substantially identical for all the fibers, thus ensuring optimum band lay-up quality.

According to an embodiment, the tension limiting system is mounted on the movable portion of the application head, so that the fiber exiting from the tension limiting system is arranged along the guide plane defined by the guide systems.

According to an embodiment, in the case of a machine intended for the application of a band formed of several fibers, the guide system is adapted to guide a plurality of fibers towards the application roller in the form of a band, the guide system comprises first and second guide means, arranged in a staggered manner, to guide the fibers towards the application roller in the form of two bundles along two guide planes, approaching one another from upstream to downstream, the tension limiting system comprising a first assembly of at least one cylinder, preferably at least two cylinders, over which the fiber(s) of a first bundles passes, and a second assembly of at least one cylinder, preferably at least two cylinders, over which the fiber(s) of a second bundles passes, the fiber(s) of the first bundle preferably being arranged at the outlet of the first assembly in a first guide plane, and the fiber(s) of the second bundle being arranged at the outlet of the second assembly in a second guide plane. The tension limiting system according to the invention advantageously makes it possible to limit tension differences between the fibers of the band, and thus to guarantee good lay-up quality.

According to an embodiment, the guide means comprise first channels and second channels intended respectively to individually receive the fibers of the first and second bundles, preferably the first channels are formed at the assembly interface between a first outer plate and a central plate, and the second channels are formed at the assembly interface between central plate and a second outer plate.

According to an embodiment, the rerouting system comprises, for each fiber, a counter-roller actuated by an actuation system, for example a pneumatic jack, between a rest position and an active position to press the fiber against at least one drive roller, the drive roller and the cylinder(s) of the tension limiting system being able to be driven in rotation by a common drive motor, preferably mounted on the moving portion, via a transmission system so that the peripheral speed of the cylinders is greater, preferably by at least 5%, e.g. about 20%, than the peripheral speed of the drive roller. The mounting of the tension limiting system on the moving portion advantageously makes it possible to use the motor of the rerouting system to drive the cylinders, by providing appropriate transmission means to obtain the desired peripheral speeds for the cylinders and the drive roller. This solution makes it possible to simplify speed control of the cylinder(s), avoid embedding a second motor on the moving portion, and thus offer a tension limiting system with a low overall dimensions and reduced weight.

The transmission means comprise, for example, one or more belts and/or one or more gearing systems, meshing with a toothed wheel associated with each cylinder, a pinion associated with the drive roller, as well as one or more pinions associated with the shaft of the drive motor, and optionally return rollers.

In the case of a machine intended for the application of several fibers, the rerouting system comprises first rerouting means comprising at least a first drive roller and counter-rollers actuated by actuation systems between a rest position and an active position to individually press the fibers of the first bundle against the first drive roller, and second rerouting means comprising at least one second drive roller and counter rollers actuated between a rest position and an active position by actuation systems to individually press the fibers of the second bundle against second drive roller, the drive rollers being driven by the common drive motor.

The machine may further comprise fiber storage means, such as a spool creel remote from the head or mounted on a support integral with the fixed portion of the head, conveying means for conveying fiber(s) from the storage means to the head, and a displacement system adapted to effect relative displacement of the head with respect to a lay-up surface, in particular able to displace the head. According to one embodiment, the conveying means comprise at least one flexible conveying tube, each conveying tube being able to receive a fiber in its internal passage.

In an embodiment, preferably when the storage means are remote from the head, and the conveying means comprise one or more conveying tubes, the machine comprises a second tension limiting system, arranged upstream of conveying means able to convey one or more fibers from the storage means to the application head. This second tension limiting system makes it possible to effectively reduce the tension of the fibers before they enter the conveying tubes, and thus to guarantee efficient conveyance of the fibers in the tubes and low fiber tension at the outlet of the conveying tubes. This low fiber tension at the outlet of the tubes can be effectively reduced, and made uniform from one fiber to another, with the tension limiting system according to the invention mounted on the moving portion of the head, in particular with a tension limiting system of reduced overall dimensions, comprising a reduced number of cylinders, for example only two cylinders for each fiber.

According to an embodiment, as described in application FR2114113 filed on 23 Dec. 2021 by the applicant, for each fiber, a belt is mounted around each cylinder, so that a belt is interposed between each fiber and the cylinder, each belt being able to adhere to a fiber and be driven more or less by the cylinder depending on the pressure exerted by the fiber on the belt. To limit the angular portion of contact between the belt and the cylinder, each belt is preferably mounted in a loop on a sliding path formed in part by the cylinder and a complementary part in the form of a crescent moon, fixedly mounted around the cylinder so that end portions of the complementary part fit tangentially onto the cylinder. Preferably, guide flanges, generally C-shaped, are able to be mounted snap-fitting onto the cylinder and the intermediate part, so that each fiber and each belt are guided between two flanges, each flange comprising at least one tab at each end, able to snap-fit elastically into a recess in the intermediate part. In this embodiment, the flanges can be easily disassembled for their replacement, or to enable the belts to be replaced.

Another object of the present invention is a method for manufacturing a composite material part comprising the application of continuous fibers onto an application surface, characterized in that the application of fibers is carried out by means of a fiber application machine as previously defined, by relative displacement of the application head with respect to the lay-up surface according to lay-up trajectories.

### BRIEF DESCRIPTION OF THE DRAWINGS

The invention will be better understood, and other purposes, details, features and advantages will become clearer in the course of the following detailed explanatory description of a currently preferred particular embodiment of the invention, with reference to the appended schematic drawings, in which:

FIG. 1 is a schematic side view of a fiber application machine according to the invention, comprising a head equipped with a tension limiting system; and,

FIG. 2 and FIG. 3 are enlarged schematic side views of the application head of FIG. 1.

### DETAILED DESCRIPTION

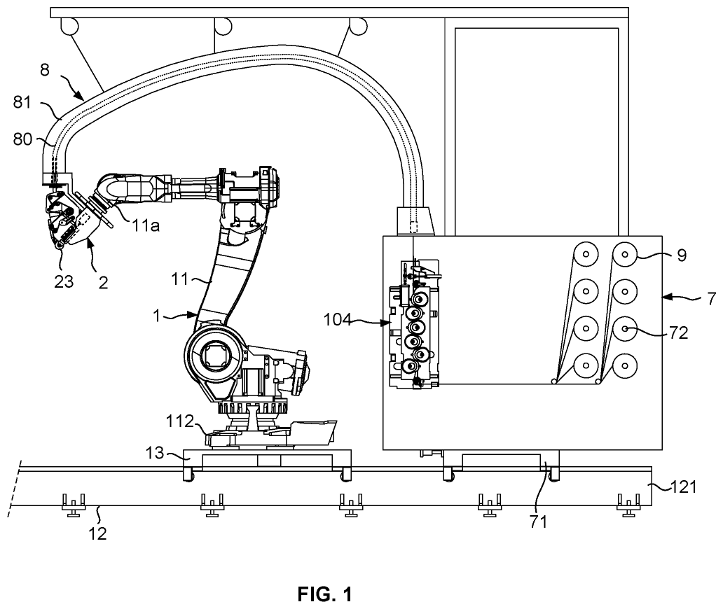

FIG. 1 schematically illustrates a fiber placement machine according to the invention, enabling the lay-up by contact on a mold of a band formed of several fibers. The application machine comprises a displacement system 1 consisting of a poly-articulated arm 11, of the six-axis robot type, known per se, mounted movably on a linear axis 12, an application head 2 mounted at the end wrist 11a of the poly-articulated arm, fiber storage means 7, and conveying means 8 for conveying fibers from storage means to the application head.

The poly-articulated arm 11 is attached by its base 112 to a carriage 13 slidably mounted on the linear axis 12, the linear axis consisting of two parallel rails 121 fixed to the floor. The carriage is equipped with drive means, such as motorized rollers, controlled by a machine control unit for the displacement of the placement head along these rails.

The fiber application head 2, also referred to as fiber placement head, comprises an application roller or compaction roller 23 able to come into contact with a mold to apply a band formed of several fibers, for example pre-impregnated with resin. The machine is designed to apply flat, continuous, ribbon-like fibers, such as carbon fibers, packaged in spool form. The storage means consist of a creel, schematically shown under reference 7, to receive the fiber spools 9. The creel is also mounted on a follower carriage 71, arranged on rails 121 and mechanically connected to the carriage 13 carrying the robot. The machine is intended here to lay up bands of eight fibers, the creel comprising eight mandrels 72, possibly motorized, to receive eight spools of fiber 9. In a manner known per se, the creel may comprise an oscillating roller or pulley over which each fiber passes, enabling the control of the rotation of the mandrel depending on the position of the oscillating roller. Similarly, a secondary mandrel can be associated with each mandrel for rewinding any separator film as the fiber is unwound.

The conveying means 8 comprise flexible conveying tubes, equipped with flexible stiffening blades, as described for example in patent WO2012/160270. The fibers are individually conveyed in these conveying tubes from the creel 7 to the head 2. The tubes are gathered into a bundle, shown schematically under reference 80 in FIG. 1, and are placed in the internal passage of a flexible sheath 81, possibly cooled to cool the fibers.

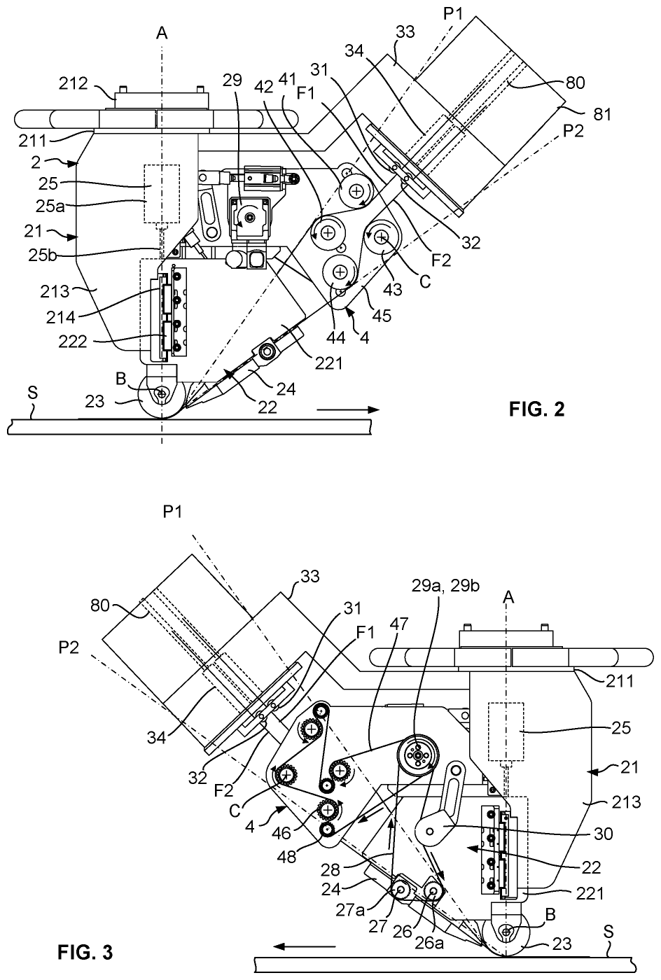

With reference to FIGS. 2 and 3, the head 2 comprises a support structure or fixed portion 21, by means of which the head is mounted on the polyarticulated arm, and on which a movable portion 22 is mounted mobile in translation. The fixed portion 21 comprises a support plate 211 provided on a first upper face with a bracket 212 for attachment, along an assembly axis A, to the end wrist of the polyarticulated arm. The support plate 211 carries on its second main face, opposite the first main face, two mounting plates 213 spaced apart and extending perpendicularly, the movable portion 22 being slidably mounted on the front edges of the mounting plates. The movable portion 22 comprises, in a manner known per se, the application roller 23, a guide system 24 for guiding the fibers towards the roller in two batches or bundles of fibers along two guide planes P1, P2, a cutting system for individually cutting each fiber, a rerouting system for individually rerouting each fiber that has just been cut, so as to be able to stop and restart the application of a fiber at any time, as well as to select the width of the web, and a clamping system for clamping each fiber that has just been cut. By way of example, the guide system, and the cutting, rerouting and clamping systems are similar to those described in patent WO2008/132299. The moving portion 22 comprises two flanges 221 interconnected by crosspieces, and between which are mounted the compaction roller, the guide system, the cutting system, the rerouting system and the clamping system. The rear edges of the flanges are equipped with carriages 214 which slide in a plane parallel to the axis A, in complementary rails 214 mounted on the front edges of the two mounting plates. The movable portion is connected to the fixed portion by at least one compaction jack 25, preferably pneumatic, for example two compaction jacks, the jacks defining the compaction force with which the fibers are applied to the mold by the compaction roller 23. Each jack is mounted by its jack body 25a on the fixed portion, and its rod 25b extends parallel to the sliding plane and is connected to the upper edge of a flange 221. The jacks urge the moving portion in the opposite direction to the support plate, i.e. vertically downwards in the configuration shown in FIG. 2. The compaction jacks, for example of the double-acting pneumatic type, are pressure-controlled to adapt the compaction force.

The guide system comprises first and second channels positioned in a staggered arrangement along two guide planes P1, P2, approaching each other from downstream to upstream, to guide the fibers to the roller in the form of two bundles of fibers. The first and second channels are designed to individually receive the fibers F1, F2 of the first and second bundles respectively. The guide system comprises, for example, three plates, preferably metallic, mounted flat against each other to define between them first guide channels and second guide channels through which the fibers of the first bundle and the second bundle respectively pass to feed them tangentially to the application roller. The first channels are formed at the assembly interface between a first outer plate and a central plate, having a triangular cross-section, and second channels are formed at the assembly interface between the central plate and a second outer plate.

The rerouting system comprises first rerouting means including a first drive roller 26, rotatably mounted in a transverse bore of the central plate, and counter-rollers actuated by actuation systems between a rest position and an active position to individually press the fibers F1 of the first bundle against first drive roller, and second rerouting means comprising a second drive roller 27, rotatably mounted on the second outer plate, and counter-rollers actuated between a rest position and an active position by actuation systems to individually press the fibers F2 of the second against second drive roller. The two drive rollers 26, 27 are driven in rotation via a belt by a motor 29 mounted on the moving part. Each drive roller is fitted at its end with a pinion 26a, 27a, a first belt 28 meshing with the pinions of the drive rollers and with a first pinion 29a mounted on the shaft of motor 29. To facilitate maintenance operations, the tension of the first belt is adjusted by a belt tensioning system 30 comprising a tensioning roller mounted at the end of a pivoting arm actuated by a jack.

The cutting system, known per se, comprises first cutting means for cutting each fiber F1 of the first bundle and second cutting means for cutting each fiber F2 of the second bundle. Similarly, the clamping system comprises first clamping means for clamping each fiber of the first bundle and second clamping means for clamping each fiber of the second bundle.

According to the invention, the head is equipped with a tension limiting system 4, mounted on the moving portion 22 upstream of the guide system 24 with respect to the moving direction of the fibers in the head, through which the fibers F1, F2 entering the head pass in order to limit, or even eliminate, the tension in the fibers applied by the compaction roller. The tension limiting system 4 comprises a first set of two rollers 41, 42 for the fibers F1 of the first bundle, and a second set of two rollers 43, 44 for the fibers F2 of the second bundle.

At the head inlet, the head comprises a row of first pulleys 31 mounted so as to rotate on a first axis to guide the F1 fibers of the first bundle coming from the tubes towards the tension limiting system, and a row of second pulleys 32 mounted so as to rotate on a second axis for the F2 fibers of the second bundle, these pulleys 31, 32 being mounted on a support 33 fixed to the fixed portion 21. Conveying tubes 80 are mounted at their ends to the support 33, upstream of the two rows of pulleys, via fastening systems 34, for example in the form of cassettes, in two parallel rows so as to form the two bundles of fibers. The sheath 81 is fixed by its end to the support 33.

At the outlet of the conveying tubes, the fibers F1 of the first bundle pass over the first pulleys 31, then over a first cylinder 41 and over a second cylinder 42. At the outlet of the second cylinder 42, the fibers F1 are arranged in the plane P1 and enter directly into the first guide channels of the guide system 24. The fibers F2 of the second web pass over the second pulleys 32, then over a first cylinder 43 and a second cylinder 44. At the outlet of the second cylinder 44, the fibers F2 are arranged in the plane P2 and enter directly into the second guide channels. Each fiber comes into contact, directly or indirectly, with a first main face against a first cylinder, then with a second main face against a second cylinder.

The rollers 41-44 of the first and second sets are rotatably mounted in a cantilevered manner on a support plate 45 which is assembled to the moving portion, the rotation axes C of the rollers 41-44 being parallel to each other, and parallel to the rotation axis B of the compaction roller 23, the rollers extending perpendicularly from a first main face of the support plate. Rollers 41-44 can be positively driven in rotation by the drive motor 28 of the rerouting system. Each cylinder is fitted with a toothed wheel 46 at its end on the side of the second main face of the carrier plate 45. The cylinders are rotated by means of a second belt 47, e.g. a double-toothed belt, which meshes with a second pinion 29b on the shaft of the drive motor 28, as well as with each toothed wheel 46 of a cylinder, the second belt also passing over return rollers 48 to define a belt path for driving all the cylinders. A tension roller system can also be provided to adjust the tension of the second belt. The diameters of the drive rollers 26, 27 and their pinions 26a, 26b, and the diameters of the rollers 41-44 and their toothed wheels 46 are defined so that the peripheral speed of the rollers 41-44 is greater, for example by around 20%, than the peripheral speed of the drive rollers. Alternatively, a single belt is provided to drive the drive rollers and the cylinders in rotation.

In operation, the drive motor 29 is controlled by the machine control unit to drive the drive rollers 26, 27 so that the peripheral speed of the rerouting rollers is equal to the peripheral speed of the compaction roller 26 pressed against a lay-up surface, the peripheral speed of the compaction roller corresponding to the speed of the TCP (Tool Center Point) on the lay-up surface S, the TCP being the mid-point of the line of intersection between the compaction roller and the lay-up surface. When the head is not in contact with the lay-up surface, for example during a linking trajectory between two lay-up trajectories, each fiber end can also be rerouted from the cutting system to the compaction roller by controlling the drive motor and the rerouting counter-roller associated with fiber.

Some fibers, due to their fragility, elasticity or lightness, cannot be in direct contact with the cylinders in rotation. To implement these fibers, as described in the aforementioned documents, belts can be mounted around each cylinder, so that a belt is interposed between each fiber and the cylinder, each belt being able to adhere to a fiber and be driven more or less by the cylinder depending on the pressure exerted by the fiber on the belt, pressure being proportional to the tension of the fiber.

In order to limit the tension of the fibers before they enter into the conveying tubes, the machine comprises a tension limiting system 104, placed in the creel, as described in the aforementioned patent documents, preferably a system corresponding to that described in patent application FR2114113.

Although the invention has been described in connection with a particular embodiment, it is clear that it is by no means limited thereto and that it includes all the technical equivalents of the means described, as well as combinations thereof, if these fall within the scope of the invention.

1. Fiber application machine for the production of composite material parts comprising a fiber application head comprising a fixed portion and a movable portion, the movable portion comprising:
a compaction system comprising at least one application roller,
a guide system for guiding at least one fiber (F1, F2) towards said application roller along a guide plane (P1, P2), and
a fiber cutting system and a fibre fiber system,
the movable portion being slidably mounted on the fixed portion, and being biased by at least one compaction jack mounted between the fixed portion and the movable portion,
the machine further comprising a tension limiting system comprising at least one cylinder on which each fiber is able to be partially wound, and drive means able to drive the cylinder in rotation,
wherein the tension limiting system is mounted on the movable portion of the application head, upstream of the guide system.

2. Machine according to claim 1, wherein the tension limiting system is mounted on the movable portion of the application head so that the fiber (F1, F2) exiting from the tension limiting system is arranged in the guide plane (P1, P2).

3. The machine according to claim 1, wherein the guide system is able to guide a plurality of fibers (F1, F2) towards the application roller in the form of a band, the guide system comprises first and second guide means for guiding the fibers towards the application roller in the form of two bundles along two guide planes (P1, P2), the tension limiting system comprising a first set of at least one cylinder over which the fiber(s) (F1) of a first bundle passes, and a second set of at least one cylinder over which the fiber(s) (F2) of a second bundle passes.

4. The machine according to claim 1, wherein the rerouting system comprises, for each fiber, a counter-roller actuated by an actuation system between a rest position and an active position to press the fiber against at least one drive roller, the drive roller and the cylinder(s) of the tension limiting system being able to be driven in rotation by a common drive motor, mounted on the moving portion, via a transmission system, so that the peripheral speed of the cylinders is greater than the peripheral speed of the drive roller.

5. The machine according to claim 1, comprising a second tension limiting system, arranged upstream of conveying means able to convey one or more fibers from storage means to the application head.

6. The method for manufacturing a composite material part comprising the application of continuous fibers onto an application surface, wherein the application of fibers is carried out by means of a fiber application machine according to claim 1, by relative displacement of the application head with respect to the lay-up surface according to lay-up trajectories.
